(19) United States
(12) Patent Application Publication
(10) Pub. No.: US 2019/0035043 A1
(43) Pub. Date: Jan. 31, 2019

(54) INVENTORY TRACKING

(71) Applicant: Walmart Apollo, LLC, Bentonville, AR (US)

(72) Inventors: Nicholaus A. Jones, Fayetteville, AR (US); Matthew A. Jones, Bentonville, AR (US)

(21) Appl. No.: 16/046,120

(22) Filed: Jul. 26, 2018

Related U.S. Application Data
(60) Provisional application No. 62/538,083, filed on Jul. 28, 2017.

(51) Int. Cl. G06Q 50/28; G08B 21/18; G01P 21/00

(52) U.S. Cl. CPC G06Q 50/28; G01P 21/00; G08B 21/182

(57) ABSTRACT

In some embodiments, apparatuses and methods are provided herein useful to identify and/or track items using accelerometer devices. In some embodiments, accelerometer devices are used to verify correct placement of items in a loading, unloading, transport, or picking operation in a supply chain facility.

### CROSS-REFERENCE TO RELATED APPLICATION

This application claims the benefit of U.S. Provisional Application No. 62/538,083, filed Jul. 28, 2017, which is incorporated by reference in its entirety herein.

### TECHNICAL FIELD

This invention relates generally to inventory management and tracking of goods within retail supply chain facilities.

### BACKGROUND

Inventory of various types is handled and/or stored at warehouses, distribution centers, cross-docking facilities, order fulfillment facilities, inventory rental facilities, packaging facilities, shipping facilities, factories, or other facilities. For example, retailers, wholesalers, rental services, and other product distributors (which may collectively be referred to as distributors) typically maintain an inventory of various items that may be ordered by clients or customers.

Goods that are erroneously unloaded from shipping vehicles and/or stored at the wrong area of a facility may be difficult to locate, and even when an error in placement is identified the misplaced inventory must be re-shelved, resulting in significant losses of time and money. Many shipping systems have only simple electronic or paper load maps, with little oversight of the process for unloading inventory and transporting it to its intended destination.

Systems have been proposed which track goods or groups of goods with RFID tags or other traceable markers, to ensure that a truck or other vehicle is properly loaded before departing for its next destination. Such systems, however, can be relatively expensive and require installation of equipment to detect and track the markers. There remains a need for improved systems and methods for providing carriers with appropriate incentives to ensure that a vehicle has been properly unloaded and its contents transported to appropriate destinations.

### BRIEF DESCRIPTION OF THE DRAWINGS

Disclosed herein are embodiments of systems, apparatuses and methods pertaining to identifying and tracking of goods in at least a supply chain facility using accelerometer devices. This description includes drawings, wherein:

FIG. 1 is a block diagram of a system for identifying and tracking items to confirm proper placement in accordance with some embodiments.

FIGS. 2A and 2B illustrate the use of a pair of accelerometer devices to determine the identity of an item, intended destination of an item, or other item characteristics in accordance with several embodiments.

FIG. 3 is an illustration of a facility in which unloaded goods are tracked in accordance with some embodiments.

FIG. 4 is a flowchart depicting an unloading operation in accordance with several embodiments.

FIG. 5 is a process of using accelerometer devices to ensure accuracy of an operation in accordance with some embodiments.

FIG. 6 is a flowchart demonstrating a method of verifying proper handling of items in a supply chain facility in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful to identify and track packages using wearable devices on opposed arms of a user. The systems, apparatuses, and methods utilize movements and relative positions of the user's arms in three-dimensional space to identify actions such as picking up and dropping off of packages or other objects, confirming that the objects have been properly transported from one point to another. In some embodiments, a method for tracking items being sorted or placed in designated locations includes receiving signals relating to the location of one or more wearable accelerometer devices worn by a user and calculating the location of the wearable accelerometer device(s) in three-dimensional space using acceleration and direction information. In some embodiments, the item to be sorted or placed in a designated location is identified by the manner in which the item is held, as measured by accelerometer devices. For instance, an accelerometer device may be worn by a user on each of opposing arms so that a maintained distance between the acceleromer devices as the user grasps and carries the item may be used to reference a database and identify the item and related information, such as destination and handling instructions. The height at which the item is carried, the height of the user's arms as they operate a cart or other device to carry the item, or other information from the accelerometer devices may also be used to identify the item and determine its destination and/or handling instructions. When used in a loading or unloading operation, these methods permits an electronic system to identify one or more destination points for each item and verify delivery to the destination point(s) without requiring the user to pause and scan the device, input information about the item into a handheld device, or carry the item to a scanning station.

In some embodiments, methods for verifying correct placement of items in at least a product sales supply chain facility comprises receiving signals from at least two wearable accelerometer devices worn on opposing arms, preferably hands, of a user, calibrating the wearable devices at known points in three dimensional space; calculating the location of each wearable accelerometer device in three dimensional space using acceleration and direction information sent by each accelerometer device; identifying an item as the user picks it up by calculating the distance between the wearable accelerometer devices when they are held a fixed distance apart for at least a preset period of time immediately following positioning of both wearable accelerometer devices at a pickup location having a known position relative to the calibration location; referencing a database to identify a destination corresponding to the item width, and tracking the item to the identified destination.

In some embodiments, the methods may further involve recording the amount of time required to arrive at the identified destination from the pickup location. In some forms, the methods may further include generating a notification if the user takes an improper route to the destination or proceeds to an incorrect destination. For instance, an alert may be generated if an angle between a vector representing movement of the accelerometer devices away from the pickup location and a vector from the pickup location to the identified destination exceeds a preselected angle, such as 90 degrees. Alternatively, or in addition, a notification may be generated if the time between when the wearable accelerometer devices are at the pickup location and when the wearable accelerometer devices arrive at the destination exceeds a preselected time limit, indicating that the user is moving too slowly. The speed of the accelerometers also may be calculated in order to determine whether the user is moving at an acceptable speed or within acceptable variation of the average speed with which the same or similar items are moved within the facility, and a notification may be optionally generated if the accelerometer devices indicate movement at an average speed below a preselected speed for a preselected sustained amount of time.

The methods according to the invention may include in some embodiments generating a notification if there is an indication that the package carried by the user has been dropped or placed in a location other than the destination indicated in the database, such as when the wearable accelerometer devices cease to be separated by the second distance before the accelerometers are within a preselected distance of the destination.

Notifications generated by the system need not be transmitted to the user. In some forms, the notifications may be sent to a monitoring system so that a manager may view the user's overall performance over a period of time and take action as needed. In some forms, the notifications may be archived to assist in performance review at a later date. In other forms, more immediate feedback may be provided directly to the user wearing the accelerometer devices by transmitting a message to the user, which may be as simple as vibrating the accelerometer devices when movement is too slow or in the wrong direction. Different patterns of vibration may be used to indicate different deficiencies in delivery status. Alternatively, more complex notifications may be provided, such as text describing a deviation from an expected path and/or potential corrective actions that are transmitted to and displayed on a mobile device, which may be separate from or integrated with the accelerometer device.

In some forms, a system may be provided for verifying correct placement of items in at least a product sales supply chain facility, the system comprising at least two wearable accelerometer device configured to measure acceleration and direction, a calibration station, a control circuit for calculating the location of each wearable accelerometer device in three dimensional space. In some embodiments, a database correlates item width to item destination, and the system's control circuit is configured to identify item destination from the database when a user holds an item so that the wearable accelerometers are held in a fixed spatial relationship relative to one another for a preset period of time, such as for at least one second. In some forms, maintaining a fixed spacing at the known x-y-z coordinates of the pickup station may be interpreted by the control circuit of the system as grasping and holding a package, and the identity of the package may be determined by the manner in which the user's hands are spaced while carrying it.

In some forms, the system continuously tracks the position of each accelerometer individually in order to assess their current position. Alternatively, or in addition, the accelerometer devices may be configured to detect proximity to one another in order to determine relative position. The accelerometer devices may be recalibrated as necessary to maintain a desired degree of accuracy. Vertical movement may advantageously be used to recalibrate the devices in some embodiments. For instance, the system may include transportation devices or rest areas of known heights at known points along a route so that shifting a package to the vertical height of the transportation device or rest area confirms the user's location and allows the accelerometers to be recalibrated. In some forms, accuracy of the accelerometer devices is maintained within about one inch through appropriate placement of rest areas.

In some forms, the system may identify a vertical dropoff position of the accelerometers when the accelerometers cease to be separated by the second distance, and reference a database to verify that the vertical dropoff position correlates to the item width. The system may also require the user to place transported items on a plurality of intermediate calibration points having known locations relative to the pickup location, the number of intermediate calibration points calculated to maintain accuracy of a calculated position of the accelerometers within one inch.

The accelerometer devices may be strapped to a user's wrist, hand, or another part of the user's arm; inserted into articles worn on the user's arm; or incorporated into wristbands, armbands, bracelets, or the like. In embodiments, the accelerometer devices may contain an integrated power supply and/or communicate with an external power supply. In some embodiments the accelerometers, a separate battery pack, and other components may all be physically integrated into a wearable article such as a jacket or vest. The accelerometer devices are configured to estimate position in three-dimensional space by double integration of physical acceleration data (with measurements of normal force and gravity excluded) gathered by one or more accelerometers in each accelerometer device. Each wearable accelerometer device should contain an accelerometer and gyroscope, or three accelerometers arranged perpendicular to one another in order to measure both magnitude of acceleration and direction in three dimensions. The accelerometer devices use three-dimensional axes to measure tilt and motion in physical space and are couple to a timing device to provide data for of movement and position over time. In some forms, the accelerometers utilize piezoelectric, piezoresistive, and/or capacitive components to convert mechanical motion into electrical signals. In some embodiments, the accelerometer devices measure voltage variances along three perpendicular axes by the use of flexing silicon fingers, bubble floats, or other techniques. The type of accelerometer device is not particularly important as long as it is small enough to be comfortably worn on a user's arm, preferably at or near the wrist, capable of measuring the magnitude and direction of acceleration, and accurate within about an inch when calculating position based on direction and acceleration. A variety of accelerometers commonly used in handheld electronics may be suitably adapted for use in the wearable accelerometer devices of the invention.

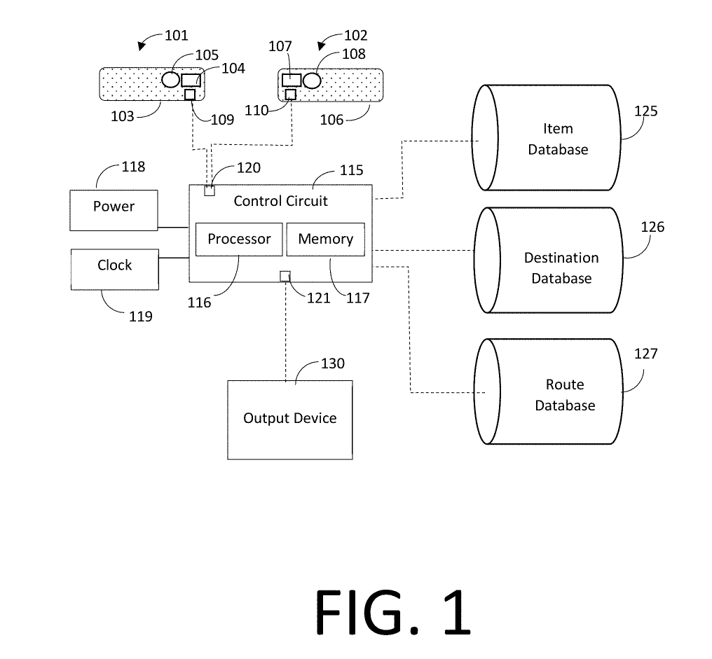

FIG. 1 illustrates one example of a tracking system incorporating a pair of wearable accelerometer devices 101 and 102. The first wearable accelerometer device includes a wrist band 103 for securing the device to a user, an accelerometer 104 for measuring magnitude of acceleration, a gyroscope 105 for determining orientation, and a transmitter 109 for sending information to a control circuit 115. The second wearable accelerometer device 102 correspondingly includes a wristband 106, accelerometer 107, gyroscope 108, and transmitter 110.

The accelerometer devices are in communication with a control circuit, preferably using any known wireless technology but the control circuit may be in some embodiments contained within one of the wearable devices 101 or 102 or hard wired to one or more of the wearable devices and worn in a backpack, vest, jacket, or other wearable item. In the illustrated form the accelerometer devices 101 and 102 communicate through transmitters 109 and 110 with a receiver 120 of a control circuit 115 that receives data regarding acceleration and direction to calculate the coordinates of each accelerometer in a three-dimensional grid system based on a known starting position. The control circuit may include a processor 116 and memory module 117. The term control circuit refers broadly to any microcontroller, computer, or processor-based device with processor, memory, and programmable input/output peripherals, which is generally designed to govern the operation of other components and devices. It is further understood to include common accompanying accessory devices. The control circuit can be implemented through one or more processors, microprocessors, central processing units, logic, local digital storage, firmware, software, and/or other control hardware and/or software, and may be used to execute or assist in executing the steps of the processes, methods, functionality, and techniques described herein. Furthermore, in some implementations the control circuit may provide multiprocessor functionality. These architectural options are well known and understood in the art and require no further description here. The control circuit 115 may be configured (for example, by using corresponding programming stored in a memory as will be well understood by those skilled in the art) to carry out one or more of the steps, actions, and/or functions described herein.

Generally, the control circuit 115 can include fixed-purpose hard-wired platforms or can comprise a partially or wholly programmable platform. These architectural options are well known and understood in the art and require no further description here. The control circuit can be configured (for example, by using corresponding programming as will be well understood by those skilled in the art) to carry out one or more of the steps, actions, and/or functions described herein, and can store instructions, code, and the like that is implemented by the control circuit and/or processors to implement intended functionality. In some applications, the control circuit and/or memory may be distributed over a communications network (e.g. LAN, WAN, Internet) providing distributed and/or redundant processing and functionality. In some implementations, the control circuit can comprise a processor 116 and a memory module 117, which may be integrated together, such as in a microcontroller, application specification integrated circuit, field programmable gate array or other such device, or may be separate devices coupled together. One or more power sources 118 may provide power to the control circuit, and may be of any known type. A clock 119 may communicate with the control circuit 115 in order to provide information regarding timing of information received from the accelerometer devices 101 and 102, or may be incorporated directly into one or both of the wearable devices.

The control circuit may access one or more databases to compare calculated position information to data regarding delivery routes and/or item destination. In the embodiment shown in FIG. 1, the control circuit is in communication with an item database 125 containing data relating to one or more characteristics of items that may be picked up and/or transported by the user of the device. For example, the item database 125 may pair information regarding size, shape, or carrying instructions with information regarding the identity of items listed on a bill of lading as scheduled for delivery to a particular facility and handling by a user of the system. In some embodiments the control circuit may be configured to identify an item such as a box or package based on the way in which it is held by the user as detected by the wearable accelerometer devices, such as by measuring the distance between the wearable accelerometer devices 101 and 102 when the item is held by the user. For instance, the database may contain for each item to be loaded or unloaded reference handling data such as item width, position of handle structures, recommended hand placement, or other information regarding the relative position of wearable accelerometers when carrying that item. Thus, when a user wears similar accelerometer devices and handles an item, the control circuit will calculate the relative positions of the accelerometers based on their starting position and detected changes in velocity over time in one or more directions and, based on the distance between accelerometers or other information regarding relative positions of the accelerometer devices on the user's arms, determine the closest match from among the reference handling data. Once the control circuit matches the calculated accelerometer device positions to a specific set of reference handling date, it will be able to identify the corresponding item identity.

The control circuit may also be in communication with a destination database 126 that identifies one or more destinations for the identified item. The destination database 126 may identify the final destination and/or one or more intermediate destinations or waypoints based on the identity of the item. For instance, when packages are unloaded and identified according to relative positions of wearable accelerometers 101 and 102, the destination database 126 may identify the location on the sales floor or in a backroom storage area to which the item is to be transported. Alternatively, or in addition, the destination database 126 may identify the location of a conveyance, such as a pallet, dolly, hand truck, picking cart, rocket cart, wagon, forklift, conveyor belt, autonomous ground vehicle, or other conveyance that will take the item toward its ultimate destination.

The control circuit may also be in communication with a route database 127 containing specific information regarding the route to be taken in delivering the item to the identified destination. For instance, the route database may identify routes based on the item identity and/or identified destination that are optimal given the destination, intervening obstacles, facility traffic patterns, or other factors. Route information may also include timing data based on estimated or average time from a starting point to the identified destination.

One or more of these databases may be eliminated in certain embodiments, or the databases or portions thereof may be merged with one another. For instance, a database may directly correlate detected item characteristics, as measured by accelerometer position, with destination or route information without directly identifying the item.

An output device 130 may be in communication with the control circuit 115 in order to provide feedback regarding use of the device to the user and/or other individuals or systems. For instance, the output device may be a computer terminal that displays information regarding the items picked up by the user and the accuracy with which the items are transported to their identified destinations. The output device may simply log information to be viewed later, or may generate alerts or notifications in real time in order to call attention to errors made by the user. In some embodiments, the output device 130 may provide alerts directly to the user and may be incorporated into one or both of the wearable devices 101 or 102 or a separate wearable device. The control circuit may contain a transmitter 121 to send wireless signals to the output device 130, or may be hardwired to the control circuit or integrated with the control circuit

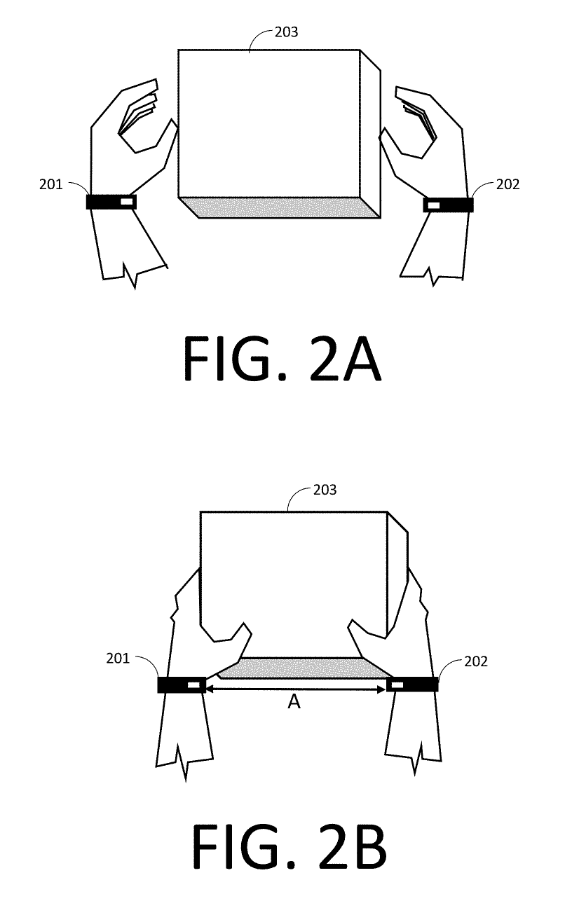

FIG. 2 demonstrates one example of how systems described herein may be used to identify and/or track an item such as a package. Wearable accelerometer devices 201 and 202 are placed on the wrists of a user and calibrated or “zeroed” at a starting position, which is a known location in three-dimensional space. The user then approaches a package 203 as shown in FIG. 2A, and the accelerometer devices 201 and 202 track movement of the user's wrists as they move toward the package. When the user grasps the package as shown in FIG. 2B, a fixed distance “A” is established between wearable accelerometer device 201 and wearable accelerometer device 202, and this distance A between the two devices is maintained as long as the user holds the package in the same manner. The system may be configured to recognize a package pickup event when the calculated distance between devices 201 and 202 remains constant for a preset period of time, such as one second or any other period of time. At that point, the system may compare the distance A to entries in a database to determine the identity, destination, and/or other information corresponding to the width of the package 203 as measured by the distance A between accelerometer devices when the user holds the package. The system may also be programmed to require other conditions to be met before a fixed distance between devices 201 and 202 is recognized as a pickup event. For instance, the system may only recognize a pickup event when the devices 201 and 202 are in a designated pickup station or other area of a facility where the items are presented for pickup, or the system may monitor the vertical positions of devices 201 and 202 to ensure that they are at a typical height for receiving and/or carrying packages. Once an item has been received by the user, regardless of where the wearable accelerometer devices 201 and 202 move in three-dimensional space, the system may confirm that the package 203 is maintained by the user by calculating the individual positions of the devices 201 and 202 and then calculating the distance between the two positions. If the distance separating the devices 201 and 202 continues to be A, or within a small preset variance (such as 0.25 inch, 0.50 inch, 0.75 inch, 1.0 inch, 1.25 inch, 1.5 inch, 1.75 inch, 2.0 inch, etc.) the system assumes that the user is still carrying the package. If the distance changes beyond the preset variance from A, the system assumes that the user has dropped or put down the package and may be programmed to generate an alert if the user is not within a preset proximity of the destination to which the package is to be delivered.

Other information measured by the wearable accelerometer devices 201 and 202 may also be utilized by the system in order to confirm item identity or appropriate handling. For instance, sudden acceleration or deceleration indicative of shocks may cause the system to issue a notification that there is potential damage to the package 203, or movement of the devices 201 and 202 consistent with tilting of the package may cause a notification to be issued even when distance A is continuously maintained between the devices if handling instructions in a database indicate that package 203 must remain upright.

If multiple different packages of the same size are presented at the same pickup station, or if it is otherwise desirable to eliminate or supplement the package identification step using the pair of accelerometer devices, additional information may be acquired to accurately identify the packages and determine the appropriate destination. For instance, the user may be required to make specific gestures using the accelerometer devices or hold the package in a specific manner in order to provide additional information regarding package type. Information regarding these additional gestures or handling instructions may be printed on the package to instruct the user to perform the appropriate hand gestures, and the database would contain information regarding these additional gestures paired with information relating to package type and destination. For instance, holding a package with the right hand on a lower edge of the package with the left hand on a side panel of the package may be indicative of a different package type than holding a package with the left hand on a lower edge with the right hand on a side panel. It is also possible to use other spatial parameters to identify package types, such as the height at which packages are grasped. Providing handles of varying height depending on package destination may permit the system to accurately identify package destination in some embodiments.

The packages handled by the user wearing devices 201 and 202 also may be scanned using conventional techniques in addition to or in place of identification by accelerometer position. For instance, the items may be scanned by one or more scanners configured to gather information from a label or tag placed on packages. For instance, packages may be placed in front of an optical sensor for scanning packages marked with a barcode, matrix barcode, or other symbol or visual designation in order to determine package identity. A RFID receiver may receive information from transmitters incorporated in or placed on packaging in order to identify items and determine the order in which packages will be handled by an individual wearing an accelerometer device. In some cases, the packages may be placed in a tunnel scanner for rapidly identifying and/or sorting prior to being handled by an individual wearing an accelerometer device.

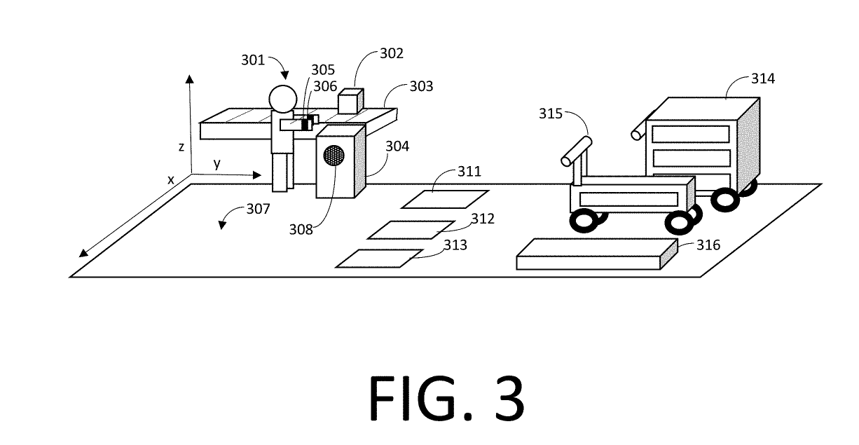

FIG. 3 illustrates one situation in which accelerometer devices may be used for item identification and tracking. A user 301 receives a package 302 unloaded from a delivery vehicle along a conveyor 303 or other unloading mechanism, although the user could alternatively directly from the delivery vehicle. The conveyer 303 delivers the package 302 to a platform 304 of known height that serves as the starting point for the tracking process. The user 301 wears a pair of accelerometer devices 305 and 306, with one device worn on each wrist (or another part of the arm). A three-dimensional area is defined, shown here as x and y axes forming a plane defined by the floor 307 of the facility and the z axis measuring vertical distance from the floor 307. The user 301 may calibrate the accelerometer devices by placing them in known positions along the x, y, and z axes and activating them. For instance, the user 301 may be instructed to contact the accelerometer devices 305 and 306 to a contact point 308 on the starting platform 304 to initiate the tracking process, with contact between accelerometer devices 305 and 306 and contact points 308 switching the accelerometer devices to an “on” state and/or zeroing the position of the devices. Alternatively, in some embodiments while activating the accelerometer devices or within a short time window of activating the devices the user may place their hands in predetermined positions designated by markings such as handprints on a wall, the starting platform 304, or other fixed structure so that the starting position of the accelerometers is known.

Once the package 302 is picked up by the user 301, its identity, destination, or other information may be determined as described in connection with FIG. 2 or another method. The determined information may then be used to provide the user with an indication regarding where to proceed, or the wearable devices 305 and 306 may simply track movements and transmit information to a control circuit (not shown) to confirm that the package 302 is transported to the appropriate location. The identified destination of the package 302 may be a conveyance such as cart 314, dolly 315, or pallet 316. Advantageously, each conveyance may have a different vertical position for receiving items so that release of the package at a certain vertical position along the z axis may be confirmed as loading the package 302 onto the appropriate conveyance. Other gestures may also be taken into account, for instance downward movement followed by separation of the wearable devices 305 and 306 may be deemed indicative of delivery of the package 302 to the pallet 316, while upward movement followed by separation of the wearable devices 305 and 306 may be deemed as placement of the package 302 to the taller cart 314. If desired, appropriate use and navigation of each conveyance may subsequently be confirmed using accelerometer devices 305 and 306, such as by maintained vertical position of the devices being determined to be consistent with the user's hands gripping the handle of the dolly 315 and proceeding in the direction of the next designated destination. The facility may be designed so that various zones each have conveyances of different heights or other characteristics detectable by the wearable accelerometer devices 305 and 306.

In order to minimize compounded error in the calculation of accelerometer position during transport of the package, one or more intermediate destinations having known positions in the x-y plane defined by the floor 307 may be provided. For instance, the user 301 may be instructed to stop at one of waypoints 311, 312, or 313 and perform a specific function in order to confirm location and recalibrate or “zero out” the wearable accelerometer devices 305 and 306. For instance, shifting the package 302 up or down in the vertical direction by a given amount may be programed to be a signal that the user is at a particular position along the x-y plane, and the system may then compare the calculated position to the expected position to assess accumulated error in tracking or simply reset tracking by considering that location as a new starting point. The waypoints may in some embodiments have a platform onto which the package is to be released at a known height to recalibrate the system in all three dimensions. Of course, actual position may also optionally be confirmed by other methods, such as GPS, triangulation using RFID tags and receivers, or other known methods. Waypoints 311, 312, and 313 or other destinations may also be equipped with scanners, sensors, or other devices to confirm that the package 302 has been transported to that waypoint or destination.

In some embodiments, a control circuit of a system may continuously or periodically calculate the current position of each accelerometer and compare the calculated positions to a designated route on an electronic map of a facility, flagging any points at which the user deviates by more than a preset distance from the designated route. In some embodiments, the control circuit may not receive information regarding a designated route, but instead generate a notification if an angle between a vector representing movement of the accelerometer devices away from the pickup location and a vector from the pickup location to the identified destination exceeds a preselected angle. In some embodiments, the control circuit may be configured to generate a notification if a time period between when the wearable accelerometer devices are at the pickup location and when the wearable accelerometer devices arrive at the destination exceeds a preselected time limit. In some embodiments, the control circuit may be configured to generate a notification if the wearable accelerometer devices cease to be separated by the second distance before the accelerometers are within a preselected distance of the destination. In some embodiments, the control circuit may be configured to calculate the speed of accelerometer movement and generate a notification if the accelerometer devices indicate movement at an average speed below a preselected speed for a preselected sustained amount of time. The notifications provided by the control circuit may, if desired, vary according to the magnitude of the error or extent of the deviation from a predetermined route, delivery speed, etc. For instance, the control circuit may vary notifications dependent upon the measure of the angle between the vector representing movement of the accelerometer devices away from the pickup location and the vector from the pickup location to the identified destination

Notification may be transmitted to a monitor or other device used by a supervisor, manager, foreman, or other individual monitoring the performance of the user wearing the accelerometer devices, or alternatively may be transmitted directly to the user. In some embodiments the notifications may comprise a message containing text indicating the nature of the error, for instance a statement that the user has deviated from the path from the pickup location to the destination or a statement indicating the amount of time in which the angle between the vector representing movement of the accelerometer devices away from the pickup location and the vector from the pickup location to the identified destination exceeds 90 degrees. The message may also indicate corrective actions to be taken, such as a statement instructing the user to travel a specified distance in a specified direction. If the notification is sent directly to the user, in some forms it may be preferred that the notification comprises a vibration or pattern of vibrations of one or more of the wearable accelerometer devices, an auditory signal, or other alert that does not require the user to view a display, stop moving, or put down an item being transported.

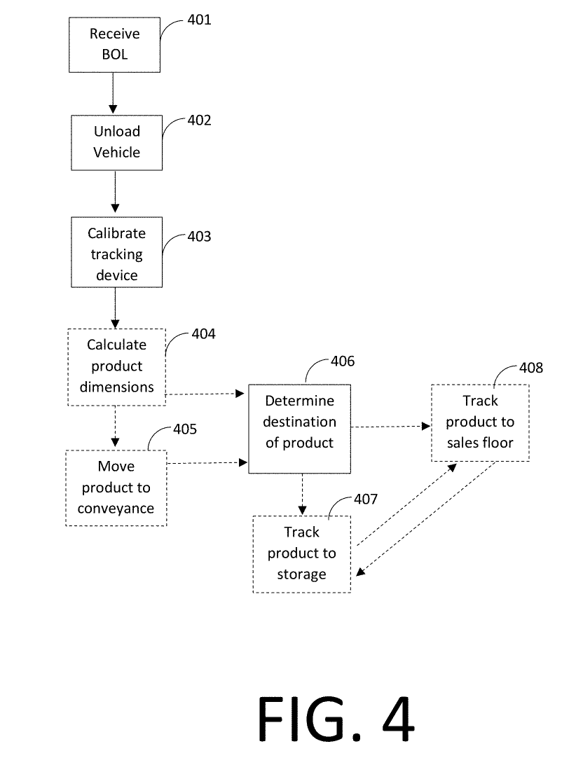

FIG. 4 is a flowchart depicting steps in one example of an unloading operation according to some embodiments. At step 41, information regarding a delivery vehicle's bill of lading (BOL) is electronically received by a control circuit to identify items scheduled to be unloaded. The vehicle is then unloaded (step 402), and during or after unloading the tracking device comprising accelerometers is calibrated by positioning the accelerometer devices at known locations in three-dimensional space (step 403). The system may optionally calculate product dimensions based on accelerometer positioning consistent with receipt and holding of an item (step 404), or alternatively or additionally may use unloading order according the BOL, scanned information from labels of unloaded goods, information from other sensors, or other techniques in order to determine the products that are picked up by users of the calibrated devices. The products may optionally be moved to a conveyance such as a hand cart (step 405), and then the system will determine the destination of the product (step 406) based on the calculation of product dimensions and/or other identification methods (step 404). The system then tracks movement of the product to storage (step 407) or to the sales floor (step 408) to verify that the product has been moved to an appropriate location. The system may also track movement of products from storage to the sales floor and vice versa.

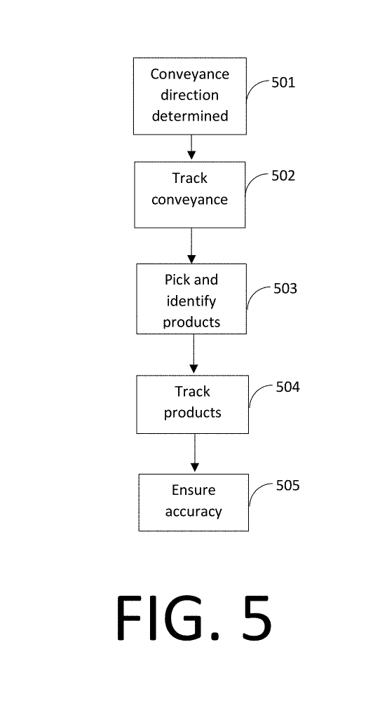

FIG. 5 illustrates one example of a process of using accelerometer devices to ensure accuracy of an unloading operation, loading operation, picking operation, or other process in which goods are moved from one location to another. Accelerometers are used to determine the direction of a conveyance carrying one or more items based on magnitude and direction of acceleration from a known starting position (step 501), and then movement of the conveyance is tracked continuously (step 502). Once the conveyance arrives at a destination, a user wearing at least one accelerometer on at least one arm, preferably at the hand or wrist, picks a product from the conveyance and the identity of the product is determined using data from the one or more accelerometers (step 503). Movement of the product is then tracked (step 504) until accelerometer readings consistent with release or deposit of the product are received, at which point the system compares the detected location with data relating to intended location in order to ensure accuracy (step 505).

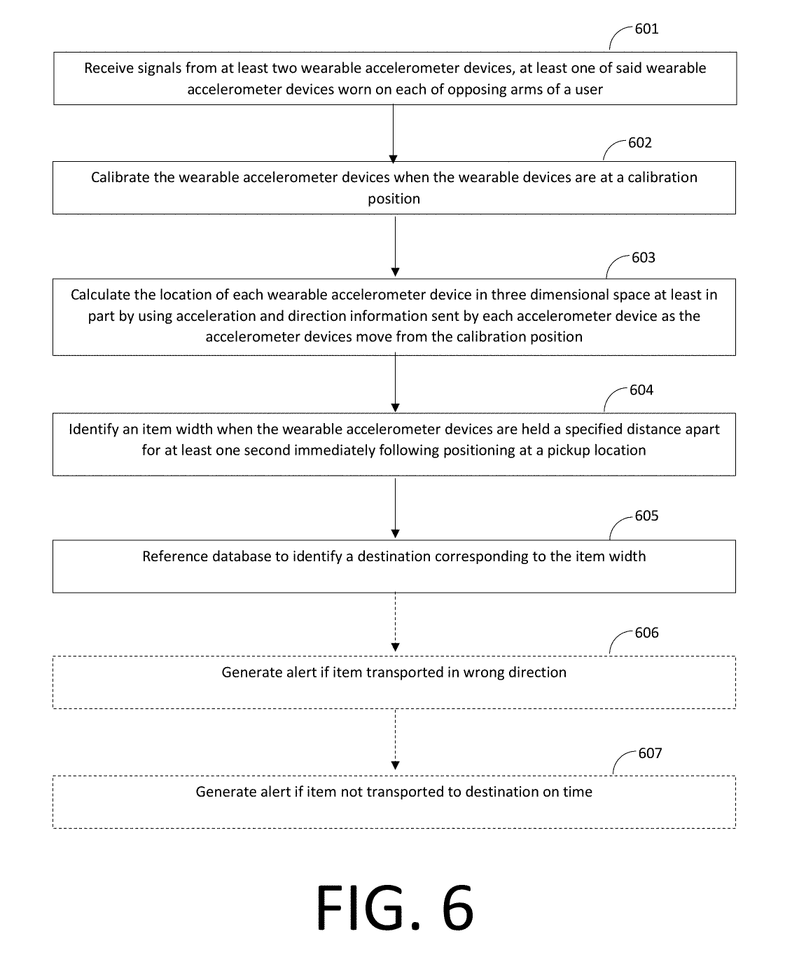

FIG. 6 illustrates a method of verifying proper handling items in a supply chain facility. A control circuit receives signals from at least two wearable accelerometer devices, at least one of said wearable accelerometer devices worn on each of opposing arms of a user (step 601). The user calibrates the wearable accelerometer devices when the wearable devices are at a calibration position having a first vertical level and first distance between accelerometers, with or without the assistance of other individuals (step 602). The control circuit then calculates the location of each wearable accelerometer device in three-dimensional space at least in part by using acceleration and direction information sent by each accelerometer device as the accelerometer devices move from the calibration position (Step 603). Based on accelerometer position, the control circuit identifies an item width when the wearable accelerometer devices are held a specified distance apart for at least one second immediately following positioning at a pickup location (step 604). The control circuit then references a database to identify a destination that corresponds to the detected item width (step 605). Optionally, the control circuit may generate an alert if the item is transported in the wrong direction (step 606) and/or if the item is not transported to the intended destination on time (step 607).

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A method for verifying correct placement of items in at least a product sales supply chain facility, the method comprising, at a control circuit:
receiving signals from at least two wearable accelerometer devices, at least one of said wearable accelerometer devices worn on each of opposing arms of a user, each accelerometer device configured to measure acceleration and direction;
calibrating the wearable accelerometer devices when the wearable devices are at a calibration position having a first vertical level and first distance between accelerometers;
calculating the location of each wearable accelerometer device in three dimensional space at least in part by using acceleration and direction information sent by each accelerometer device as the accelerometer devices move from the calibration position;
identifying an item width when the wearable accelerometer devices are held a second distance apart for at least one second immediately following positioning of both wearable accelerometer devices at a pickup location having a known position relative to the calibration location and having a second vertical level; and
referencing a database to identify a destination corresponding to the item width.

2. The method of claim 1, further comprising generating a notification if an angle between a vector representing movement of the accelerometer devices away from the pickup location and a vector from the pickup location to the identified destination exceeds a preselected angle.

3. The method of claim 1, further comprising generating a notification if a time period between when the wearable accelerometer devices are at the pickup location and when the wearable accelerometer devices arrive at the destination exceeds a preselected time limit.

4. The method of claim 1, further comprising generating a notification if the wearable accelerometer devices cease to be separated by the second distance before the accelerometers are within a preselected distance of the destination.

5. The method of claim 1, further comprising calculating speed of accelerometer movement and generating a notification if the accelerometer devices indicate movement at an average speed below a preselected speed for a preselected sustained amount of time.

6. The method of claim 1, wherein the notification is transmitted to the user wearing the accelerometer devices.

7. The method of claim 1, wherein the notification is a message containing text indicating that the user has deviated from the path from the pickup location to the destination.

8. The method of claim 1, wherein the notification is a message containing text indicating the amount of time in which the angle between the vector representing movement of the accelerometer devices away from the pickup location and the vector from the pickup location to the identified destination exceeds 90 degrees.

9. The method of claim 1, wherein the notification is a vibration of one or more of the wearable accelerometer devices.

10. The method of claim 1, further comprising identifying a vertical dropoff position of the accelerometers when the accelerometers cease to be separated by the second distance, and referencing a database to verify that the vertical dropoff position correlates to the item width.

11. The method of claim 1, further comprising placing the item on a plurality of intermediate calibration points having known locations relative to the pickup location, the number of intermediate calibration points sufficient to maintain accuracy of a calculated position of the accelerometers within one inch.

12. The method of claim 1, further comprising varying notifications dependent upon the angle between the vector representing movement of the accelerometer devices away from the pickup location and the vector from the pickup location to the identified destination.

13. The method of claim 1, further comprising identifying the item by scanning a label affixed to the item.

14. The method of claim 1, further comprising identifying the item by receiving data from a RFID tag affixed to the item.

15. A system for verifying correct placement of items in at least a product sales supply chain facility, the system comprising:
at least two wearable accelerometer devices, at least one of said wearable accelerometer devices worn on each of opposing arms of a user, each accelerometer device configured to measure acceleration and direction;
a calibration station having a first vertical level;
a control circuit for calculating the location of each wearable accelerometer device in three dimensional space at least in part by using acceleration and direction information sent by each accelerometer device following calibration at the first vertical level of the calibration station;
a pickup station having a known position relative to the calibration location and having a second vertical level; and
a database correlating item width to item destination;
wherein the control circuit is configured to identify item destination from the database when a user holds an item so that the wearable accelerometers are held in a fixed spatial relationship relative to one another for at least one second at the second vertical level at the pickup station.

16. The system of claim 15, wherein the control circuit further configured to generate a notification if an angle between a vector representing movement of the accelerometer devices away from the pickup station and a vector from the pickup station to the identified destination exceeds 90 degrees.

17. The method of claim 15, wherein the control circuit is further configured to generate a notification if the time the between when the wearable accelerometer devices are at the pickup location and when the wearable accelerometer devices arrive at the destination exceeds a preselected time limit.

18. The system of claim 15, wherein the control circuit is further configured to generate a notification if the wearable accelerometer devices cease to be held in the fixed spatial relationship relative to one another before the accelerometers are within a preselected distance of the destination.

19. The system of claim 15, wherein the database further correlates item width to a destination height and the control circuit is further configured to generate a notification if the wearable accelerometer devices cease to be held in the fixed spatial relationship relative to one another when the accelerometers are at a vertical position outside of a preselected range from the destination height.

20. The system of claim 15, further comprising a plurality of intermediate calibration stations having varying heights and known locations relative to the pickup location, the control circuit configured to identify the calibration stations by the vertical height at which a user places the item at each intermediate calibration station, the number of intermediate calibration stations sufficient to maintain accuracy of a calculated position of the accelerometers within one inch.
